(19) United States
(12) Patent Application Publication
(10) Pub. No.: US 2026/0141106 A1
(43) Pub. Date: May 21, 2026

(54) Automatic De-identification of Sensitive Data

(71) Applicant: Oracle International Corporation, Redwood Shores, CA (US)

(72) Inventors: Praphul Singh, Pleasanton, CA (US); Neil Jonathon Hauge, Raleigh, NC (US); Cody Nicholas Maheu, Nashua, NH (US); Gyan Shankar, Fremont, CA (US); Wan Jie Chen, Renton, WA (US); Irfan Bulu, Sartell, MN (US); Srinivasa Phani Kumar Gadde, Fremont, CA (US); Kent John Grueneich, West Fargo, ND (US); Brent Edward Beardsley, Bozeman, MT (US); Brad Warren Jacobs, Edmonds, WA (US)

(73) Assignee: Oracle International Corporation, Redwood Shores, CA (US)

(21) Appl. No.: 18/948,658

(22) Filed: Nov. 15, 2024

(51) Int. Cl. G06F 21/62

(52) U.S. Cl. CPC G06F 21/6245

(57) ABSTRACT

Techniques for automatically deidentifying sensitive information in textual data using large language models (LLMs) are disclosed. A process iteratively identifies and removes sensitive entities from input text by sending portions to an LLM for analysis. The LLM determines if specific entities are sensitive, and based on its output, the identified entities are removed, and the text is updated. This cycle repeats for a predetermined number of iterations until no sensitive entities remain or until another termination condition is met. The method addresses limitations of traditional de-identification approaches by leveraging LLMs' advanced language understanding capabilities while managing computational resources efficiently. By employing an iterative approach, the accuracy and thoroughness of de-identification is improved, effectively removing sensitive information while preserving the text's usefulness. This process offers technical advantages in protecting sensitive information, adapting to diverse and context-dependent data, and optimizing computational resources for improved efficiency and reliability in de-identification tasks.

### TECHNICAL FIELD

This disclosure relates generally to computer-implemented data processing. More particularly, this disclosure relates to computer-implemented de-identification of sensitive data.

### BACKGROUND

De-identification of sensitive data involves removing or obscuring personally identifiable information and other sensitive information from electronic data records. This process aims to protect privacy while allowing data to be used for research or analysis.

Manual de-identification of sensitive data involves human reviewers meticulously examining and redacting personally identifiable information from individual electronic data records. This process requires extensive time investment, for a document requires careful examination for potential identifiers. Costs escalate rapidly due to the labor-intensive nature of the task that requires skilled personnel with knowledge of privacy regulations and domain terminology. Scalability becomes a significant challenge when confronted with large datasets. As volume increases, the time and resources required grow linearly, if not exponentially.

Human reviewers are susceptible to fatigue and errors, particularly when dealing with extensive electronic data records. Consistency in applying de-identification rules across a large corpus proves difficult to maintain. Furthermore, manual processes struggle to keep pace with the ever-increasing generation of electronic data records and other sensitive data sources. The inherent limitations of human processing speed create bottlenecks in data flow, impeding timely analysis and research.

While manual review may be suitable for small, sensitive datasets, the approach quickly becomes impractical for big data applications in healthcare and medical research, financial services, education, and government and public administration. Automated or semi-automated de-identification tools offer more viable solutions for handling large-scale sensitive data de-identification tasks though these methods present their own challenges in terms of accuracy and adaptability to diverse data formats.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates iteratively identifying sensitive entities in input text and generating output text without those entities using large language models in accordance with one or more embodiments;

FIG. 2 illustrates creating a new input text for a next iteration of an iterative de-identification process by eliminating a specific element from a previous version of the text in accordance with one or more embodiments;

FIG. 3 illustrates an output from a language model that includes a modified version of the input text in accordance with one or more embodiments;

FIG. 4A and FIG. 4B illustrate grouping sensitive information types, querying language models with specific prompts for groups, and combining the results in accordance with one or more embodiments;

FIG. 5 illustrates identifying different types of sensitive information using specialized prompts and language models in accordance with one or more embodiments;

FIG. 6 illustrates masking multiple sensitive elements in a text by replacing them with a uniform placeholder or hash value in accordance with one or more embodiments;

FIG. 7 illustrates concluding an iterative sensitive information detection when no further sensitive elements are found in the text in accordance with one or more embodiments;

FIG. 8 illustrates limiting the sensitive information detection process to a predetermined number of iterations in accordance with one or more embodiments;

FIG. 9 illustrates a process for iterative de-identification of sensitive entities in an input text using large language models (LLMs) in accordance with one or more embodiments;

FIG. 10 illustrates an example transformer architecture that may be used in the implementation of an LLM in accordance with one or more embodiments; and

FIG. 11 illustrates an example computer system for use in the implementation of iterative de-identification of sensitive entities in an input text using large language models (LLMs) in accordance with one or more embodiments.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.

The following table of contents is provided for the reader's convenience and is not intended to define the limits of the disclosure.
1. GENERAL OVERVIEW
2. ITERATIVELY IDENTIFYING SENSITIVE ENTITIES IN INPUT TEXT AND GENERATING OUTPUT TEXT WITHOUT THOSE ENTITIES USING LARGE LANGUAGE MODELS
3. CREATING A NEW INPUT TEXT FOR A NEXT ITERATION OF AN ITERATIVE DE-IDENTIFICATION PROCESS BY ELIMINATING A SPECIFIC ELEMENT FROM A PREVIOUS VERSION OF THE TEXT
4. OUTPUT FROM A LANGUAGE MODEL THAT INCLUDES A MODIFIED VERSION OF THE INPUT TEXT
5. GROUPING SENSITIVE INFORMATION TYPES, QUERYING LANGUAGE MODELS WITH SPECIFIC PROMPTS FOR GROUPS, AND COMBINING THE RESULTS
6. IDENTIFYING DIFFERENT TYPES OF SENSITIVE INFORMATION USING SPECIALIZED PROMPTS AND LANGUAGE MODELS
7. MASKING MULTIPLE SENSITIVE ELEMENTS IN A TEXT BY REPLACING THEM WITH A UNIFORM PLACEHOLDER OR HASH VALUE
8. CONCLUDING AN ITERATIVE SENSITIVE INFORMATION DETECTION WHEN NO FURTHER SENSITIVE ELEMENTS ARE FOUND IN THE TEXT
9. LIMITING THE SENSITIVE INFORMATION DETECTION PROCESS TO A PREDETERMINED NUMBER OF ITERATIONS
10. PROCESS FOR ITERATIVE DE-IDENTIFICATION OF SENSITIVE ENTITIES IN AN INPUT TEXT USING LARGE LANGUAGE MODELS (LLMS)
11. EXAMPLE EMBODIMENT
12. PRACTICAL APPLICATIONS, ADVANTAGES, AND IMPROVEMENTS
13. EXAMPLE LLM ARCHITECTURE
14. COMPUTER NETWORKS AND CLOUD NETWORKS
15. HARDWARE OVERVIEW
16. MISCELLANEOUS; EXTENSIONS

### 1. GENERAL OVERVIEW

One or more embodiments de-identify sensitive information in textual data using large language models (LLMs). The system operates through an iterative process where portions of text are sent to an LLM, which identifies sensitive entities for removal. After each removal, the updated text is reanalyzed by the LLM until either no sensitive entities remain, or a predetermined termination condition is met. This approach addresses limitations of traditional de-identification methods, which often rely on static rules or models that struggle with unstructured or complex texts and diverse sensitive entities. The iterative methodology offers technical advantages over single pass approaches by systematically refining the input text, enhancing accuracy, and managing computational resources more efficiently. By incrementally processing and updating the text based on LLM outputs, the system achieves more thorough sensitive entity removal while preserving the utility of non-sensitive data. This dynamic approach adapts to context-dependent sensitive information and optimizes processing time by focusing on portions containing sensitive content, resulting in a more robust de-identification process.

One or more embodiments described in this Specification and/or recited in the claims may not be included in the General Overview section.

### 2. ITERATIVELY IDENTIFYING SENSITIVE ENTITIES IN INPUT TEXT AND GENERATING OUTPUT TEXT WITHOUT THOSE ENTITIES USING LARGE LANGUAGE MODELS

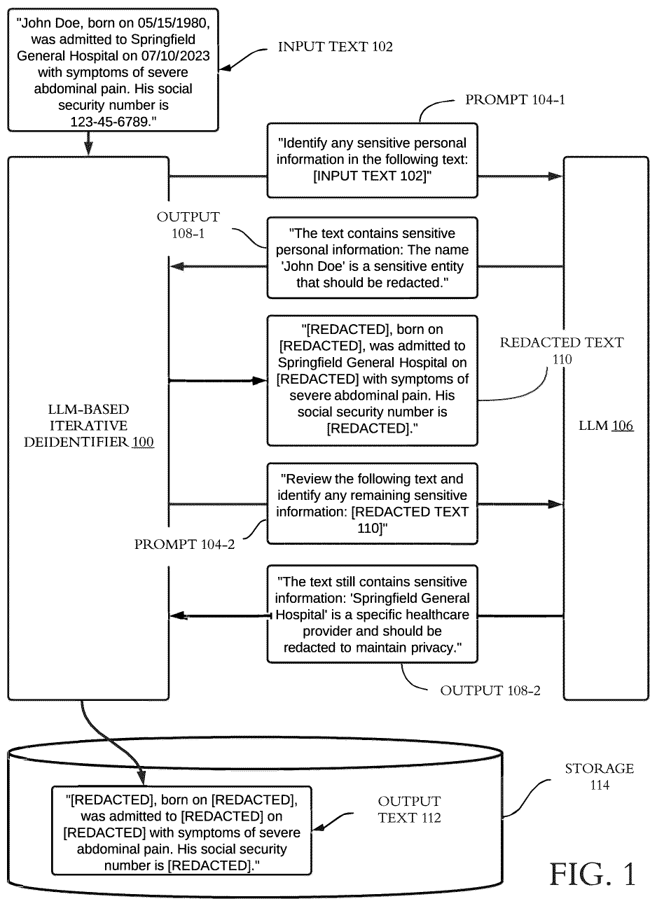

FIG. 1 illustrates iteratively identifying sensitive entities in input text and generating output text without those entities using LLMs in accordance with one or more embodiments. At a high level, FIG. 1 illustrates a method performed by an LLM-based iterative de-identifier system 100. The system comprises at least one device with a hardware processor. The method begins with an input text 102 that undergoes iterative processing to identify and remove sensitive entities. The system sends a prompt 104-1 including the input text, or a portion thereof, to a large language model (LLM) 106. The LLM 106 processes this prompt and generates an output 108-1. This output indicates if any entities in the text are deemed sensitive.

Based on the LLM's output, the system determines a redacted text 110. This new text includes portions of the original input but excludes the identified sensitive entity. The process continues with a prompt 104-2 including the redacted text. This prompt is sent to an LLM, which may be the same as or different from the LLM to which prompt 104-1 was sent. The LLM processes the prompt and produces an output 108-2.

This iterative cycle of prompting, analysis, and text refinement continues until a termination condition is met. The result is an output text 112 that retains relevant information from the input text 102 while excluding identified sensitive entities. This output text is then stored on a non-transitory, computer-readable medium 114 for future use or reference.

The LLM-based iterative de-identifier system 100 is a computer system designed for the automatic removal of sensitive information from textual data. This system employs one or more LLMs in an iterative process to identify and eliminate sensitive entities within input text. The system comprises at least one device equipped with a hardware processor. Through a series of prompts and analyses, the system systematically refines input text, using the advanced contextual understanding of LLMs to detect nuanced sensitive information. The iterative nature of the system allows for multiple passes over the text, supporting thorough detection and removal of sensitive entities that might be overlooked in single-pass approaches.

The input text 102 refers to the initial textual data submitted to the LLM-based iterative de-identifier system 100 for processing. This text comprises unstructured or semi-structured content potentially including sensitive information that requires removal. The input text 102 serves as the primary source material for the de-identification process. The content of this text may vary widely in length, complexity, and subject matter, potentially encompassing different types of documents, such as medical records, legal transcripts, or personal communications. The input text 102 undergoes iterative analysis and refinement through interactions with LLMs. Throughout the de-identification process, portions of the input text 102 may be extracted, analyzed, and modified to progressively remove sensitive entities while preserving the text's overall context and non-sensitive information.

In one or more embodiments, the input text 102 originates from a longitudinal patient record structured in Fast Healthcare Interoperability Resources (FHIR) format. FHIR is a standardized framework for exchanging electronic health records, providing a comprehensive and interoperable representation of patient data. The longitudinal nature of the record includes a chronological series of medical encounters, treatments, and observations over an extended period. This FHIR-formatted text encompasses various resource types, such as Patient, Observation, Condition, and Medication Statement, including detailed clinical information.

The longitudinal patient record presents a hierarchical structure with interconnected data elements. These elements may include personal identifiers, demographic information, medical histories, laboratory results, and treatment plans. The FHIR format's use of JavaScript Object Notation (JSON) or XML serialization allows for a structured representation of medical data.

In one or more embodiments, the input text 102 is derived from a specific field within a longitudinal patient record structured in FHIR format. Rather than encompassing the entire FHIR document, the system focuses on a particular data element or attribute. This targeted approach allows for more granular processing of sensitive information within the complex FHIR structure. The field in question could be, for example, the “note” field within an Observation resource or the “description” field of a Condition resource.

The input text 102 in this context represents a discrete piece of information within the broader patient record. This field-specific text may include unstructured narrative data, such as clinical notes, patient-reported symptoms, or detailed medical assessments. By isolating this field, the LLM-based iterative de-identifier system 100 can apply its de-identification process to a more focused dataset. This approach is useful when certain FHIR fields are known to include sensitive information that requires careful handling.

In one or more embodiments, a schema is employed to systematically identify and select specific fields from the longitudinal patient record for submission to the LLM-based iterative de-identifier system 100. The schema serves as a structured blueprint, defining the FHIR resources and their corresponding fields that require de-identification processing. This approach enables a more targeted and efficient de-identification process, focusing the system's efforts on data elements most likely to include sensitive information.

The schema is designed to map the complex structure of FHIR resources, specifying precise paths to fields that may include sensitive data. For instance, the schema may designate the Patient resource's “name” and “address” fields, the Observation resource's “note” field, or the Condition resource's “description” field as candidates for de-identification. By utilizing this schema, the system can traverse the FHIR document hierarchy, extracting relevant fields for processing.

This schema-driven approach offers several advantages. One, it allows for customization based on specific privacy requirements or regulatory standards, as the schema can be tailored to include or exclude certain fields as needed. Two, it improves processing efficiency by reducing the volume of data sent to the de-identification system and focusing on fields with potential sensitive content. Three, the schema provides a consistent and reproducible method for selecting fields across multiple patient records, ensuring uniformity in the de-identification process. This structured approach to field selection enhances the system's ability to handle complex, hierarchical data formats like FHIR while maintaining a high level of precision in sensitive data identification and removal.

In one or more embodiments, the schema serves a multifaceted role in optimizing the de-identification process for the longitudinal patient record. The schema identifies fields for LLM-based de-identification and categorizes fields based both on their sensitivity and the most appropriate de-identification method. This approach allows for a more nuanced and efficient handling of the FHIR-formatted data.

The schema explicitly designates fields that do not include sensitive information, such as non-identifiable metadata or standardized codes. These fields are exempt from the de-identification process, preserving their original content and structure within the FHIR document. Additionally, the schema identifies fields that may include sensitive information but can be effectively deidentified using more computationally efficient, non-LLM-based methods. For example, fields including structured data, such as dates of birth or zip codes, can be processed using traditional anonymization techniques, such as generalization or k-anonymity.

By employing this schema, the system 100 can route different fields to the most appropriate de-identification method. Fields requiring complex contextual understanding are directed to the LLM-based iterative de-identifier system 100, while simpler fields undergo rule-based de-identification processes. This tiered approach enhances the overall efficiency of the de-identification process, reducing computational overhead and processing time. The schema-driven method provides a balance between thorough protection of sensitive information and preservation of data utility, tailoring the de-identification strategy to the specific characteristics of a FHIR field. This approach allows for scalable and adaptable de-identification of large volumes of patient records, optimizing resource utilization while maintaining high standards of privacy protection.

As used herein, a “sensitive entity” refers to a specific piece of information within a text that, if disclosed, could potentially compromise an individual's privacy, security, or well-being. These entities encompass a wide range of data types, including but not limited to personal identifiers, protected health information, financial data, and confidential business information. Sensitive entities are characterized by their capacity to uniquely identify an individual or reveal private aspects of their life when combined with other available information. The classification of an entity as sensitive often depends on contextual factors, regulatory requirements, and the potential risks associated with its disclosure. In the realm of data privacy and information security, sensitive entities may need special handling, protection, obfuscation, or removal during data processing and sharing. The identification and management of sensitive entities are components of data protection strategies, for example, in numerous fields, including healthcare, finance, and legal services, where privacy regulations govern the handling of personal and confidential information.

In one or more embodiments, the input text 102 is sourced from an automated speech-to-text conversion process, transforming spoken language into written form for subsequent de-identification. The speech-to-text conversion, employing natural language processing (NLP) and machine learning algorithms, captures verbal communications, such as medical dictations, patient interviews, or telehealth consultations. The resulting input text 102 possesses characteristics of transcribed speech, including potential inconsistencies in punctuation, capitalization, and formatting. Transcription errors or misinterpretations by the speech-to-text system may introduce additional complexities. These features can affect the identification of sensitive entities, as the text may lack the structural cues typically present in manually written documents. Furthermore, spoken language often includes colloquialisms, repetitions, and disfluencies that can complicate the de-identification process. The iterative nature of the system 100 is useful in this context, allowing for multiple passes to identify sensitive information that might be obscured by transcription errors or inaccuracies.

The prompt 104-1 is a structured input query sent to the LLM 106 as part of the iterative de-identification process. This prompt includes a target input text, which is either the original input text 102 or includes at least a portion thereof. The prompt 104-1 is designed to elicit a response from the LLM regarding the presence of sensitive entities within the provided text. The prompt's formulation is useful for guiding the LLM's analysis and ensuring accurate identification of sensitive information. The prompt 104-1 may include specific instructions or context to direct the LLM's attention towards potential sensitive entities. The exact content and format of the prompt 104-1 can be tailored to optimize the LLM's performance in detecting various types of sensitive information.

As used herein, a “prompt” is a crafted input provided to a language model to elicit a specific type of response or behavior. In the context of NLP and artificial intelligence, prompts serve as instructions or queries that guide the model's output generation. Prompts can range from simple questions to complex scenarios or task descriptions. The structure and content of a prompt significantly influence the quality and relevance of the model's response. Effective prompts are designed to leverage the model's trained capabilities while constraining the output to the desired format or topic. Prompt engineering, the art of designing and refining these inputs, is useful for optimizing model performance across various applications. Well-constructed prompts can enhance the accuracy, coherence, and usefulness of a language model's outputs.

In one or more embodiments, the prompt 104-1 is structured to include explicit instructions for the LLM 106 to identify sensitive entities within the target input text. The prompt incorporates a predefined set of sensitive entity types that serves as a classification framework for the LLM's analysis. This set may encompass various categories, such as personal identifiers, financial information, medical data, or other domain-specific sensitive information. The prompt 104-1 directs the LLM to analyze the target input text for any occurrences of entities that match these predefined sensitive types. By specifying the sensitive entity types within the prompt itself, this approach provides clear guidelines for the LLM's entity recognition task. The LLM then processes the target input text, comparing a potential entity against the provided classification set. This targeted instruction enhances the precision of sensitive entity identification, as the LLM's analysis is constrained to a well-defined scope of sensitivity criteria. Consequently, the output 108-1 generated by the LLM is more likely to accurately flag entities that fall within the specified sensitive categories, improving the overall effectiveness of the iterative de-identification process.

In one or more embodiments, the predefined set of sensitive entity types encompasses a range of categories, covering various aspects of personal, financial, and medical information. The set includes basic personal identifiers, such as PERSON, ADDRESS, and AGE, as well as more nuanced demographic information like APPROXIMATE_LOCATION, MARITAL_STATUS, PARENTHOOD, OCCUPATION, RACE, ETHNICITY, and LANGUAGE. Temporal information is captured through categories, like DATE_AND_TIME, DATE, TIME, FREQUENCY, INTERVAL, and DURATION. The set also covers highly sensitive personal identifiers, including SSN_OR_TAXPAYER, EMAIL, PASSPORT_NUMBER_US, TELEPHONE_NUMBER, and DRIVER_ID_US. Financial data is represented by categories, such as BANK_ACCOUNT_NUMBER, BANK_SWIFT, BANK_ROUTING, and CREDIT_DEBIT_NUMBER. Medical information is addressed through types, like MEDICAL_RECORD_NUMBER, HEALTH_PLAN_ID, and CERTIFICATE_NUMBER. The set further includes unique identifiers, like FIN, VEHICLE_LICENSE_PLATE_US, VEHICLE_IDENTIFIER_US, and GUID. Digital and network-related information is covered by URL, IP_ADDRESS, and MAC_ADDRESS. The set also includes broader categories, like ORGANIZATION, as well as more specific ones, such as PHARMACY and DIAGNOSTIC LABS. An OTHER category allows for flexibility in capturing sensitive entities that may not fit precisely into the predefined types. This extensive set of entity types enables the LLM to perform a thorough and granular analysis of potential sensitive information within the input text.

In one or embodiments, the output text 108-1 generated by the LLM 106 provides an analysis of the target input text, explicitly specifying the sensitive entity type for an identified sensitive entity. The output is structured to associate a detected sensitive entity with its corresponding classification from the predefined set of sensitive entity types. For instance, the output 108-1 might list a sensitive entity alongside its categorization, such as “John Doe: PERSON” or “123 Main Street: ADDRESS”. This labeling provides a greater understanding of the sensitive information present in the text. The granularity of the output allows for targeted removal or redaction of specific types of sensitive information in subsequent processing steps. By providing this level of detail, the output 108-1 facilitates more de-identification strategies, allowing for differential treatment of various sensitive entity types. The specificity of the entity type information in the output 108-1 enhances the system's ability to make informed decisions about how to handle a sensitive entity in the iterative de-identification process.

The LLM 106 is an NLP model designed to understand and generate human-like text. This LLM is built on a deep neural network architecture, comprising many parameters (e.g., billions) trained on vast corpora of text data. The LLM 106 utilizes techniques, such as attention mechanisms and transformer architectures, to process and analyze input text with high accuracy. Capable of performing various language tasks, the LLM 106 excels in context understanding, entity recognition, and semantic analysis. The model's primary function in this system is to identify sensitive entities within the provided input text based on the instructions and context given in the prompt 104-1. The LLM 106 uses its extensive training to recognize patterns, understand context, and make nuanced judgments about the sensitivity of information in the text. The model's output serves as a useful component in the iterative de-identification process, guiding subsequent steps in sensitive information removal.

The LLM 106 can be implemented using various language model architectures. One possible implementation is based on the Generative Pre-trained Transformer (GPT) architecture that utilizes a deep neural network with multiple transformer layers. This implementation excels in generating coherent and contextually relevant text, making it suitable for identifying sensitive entities in complex linguistic contexts. Another implementation could leverage the Bidirectional Encoder Representations from Transformers (BERT) architecture, which is particularly adept at understanding bidirectional context in text. BERT-based models are especially effective for tasks like named entity recognition, which aligns well with sensitive entity identification. A third possibility is the use of a Text-to-Text Transfer Transformer (T5) model that frames NLP tasks as text-to-text problems. This approach allows the T5-based LLM to handle the sensitive entity identification task as a specialized form of text generation. These implementations offers unique strengths in processing and analyzing text, and the choice among them would depend on specific requirements such as processing speed, accuracy, and the nature of the sensitive entities being targeted.

The LLM 106 can be implemented as either a general-purpose or foundational LLM, or as a specialized fine-tuned model for sensitive entity recognition. In the case of a general-purpose LLM, the model leverages its broad knowledge base and language understanding capabilities to identify sensitive entities based on context and the provided prompt. This approach benefits from the model's extensive pre-training on diverse datasets, allowing for flexibility in recognizing various types of sensitive information. Alternatively, the LLM 106 can be a fine-tuned version of a foundational model, specifically optimized for sensitive entity recognition. This fine-tuning process involves additional training on domain-specific datasets including examples of sensitive entities and their contexts. The fine-tuned model retains the general language understanding of its base architecture while developing enhanced capabilities in identifying and classifying sensitive information. This specialized training can potentially improve the model's accuracy and efficiency in detecting subtle or domain-specific sensitive entities, making it particularly well-suited for the de-identification task at hand.

The output 108-1 is the processed result generated by the LLM 106 based on the prompt 104-1. This output includes the LLM's analysis and identification of sensitive entities within the target input text. The output 108-1 includes a structured representation of the detected sensitive information, listing an identified sensitive entity along with its corresponding classification from the predefined set of sensitive entity types. The format and content of the output 108-1 are designed to facilitate easy parsing and interpretation by subsequent components of the LLM-based iterative de-identifier system 100. The output 108-1 serves as an intermediary step in the iterative de-identification process, providing information for determining which entities should be removed or modified in the next iteration. The accuracy and comprehensiveness of the output 108-1 influences the effectiveness of the overall de-identification process.

As used herein, LLM output refers to the generated response or result produced by an LLM in response to a given input or prompt. This output encompasses text that the model generates based on its training and the context provided in the input. The output can vary in length, complexity, and format depending on the specific task and the instructions given to the model. LLM outputs may include answers to questions, completions of partial text, translations, summaries, or generated content adhering to specified parameters. The quality and relevance of the output depend on several factors, such as the model's architecture, training data, and the clarity and specificity of the input prompt. LLM outputs are probabilistic in nature, meaning the model selects a word or token based on learned probabilities; this can lead to variations in repeated runs with the same input.

In one or more embodiments, the output text 108-1 is structured in JavaScript Object Notation (JSON) format or a similar lightweight data interchange format. This structured approach facilitates parsing and interpretation by subsequent components of the LLM-based iterative de-identifier system 100. The JSON structure organizes the identified sensitive entities into a hierarchical, key-value paired format. A detected sensitive entity is represented as a JSON object, including various properties, such as the entity's text, its position in the original input, and its classified sensitive entity type. The use of JSON allows for easy nesting of complex data structures, enabling the representation of relationships between entities or additional metadata if required. This format's machine readability enhances the efficiency of downstream processing, allowing for quick extraction and manipulation of the identified sensitive information. The standardized structure of JSON also promotes interoperability, enabling the output to be easily consumed by various components or even external systems, regardless of their underlying technology stack. By employing this structured format, the output 108-1 provides a versatile and robust intermediate representation, streamlining the iterative de-identification process.

In one or more embodiments, the output 108-1 includes a modified version of the target input text with the identified sensitive entities removed. The LLM 106 processes the target input text, identifies sensitive entities based on the instructions in the prompt 104-1, and then generates an output that excludes these entities. This approach effectively combines the identification and removal steps within the LLM's processing. The resulting output 108-1 presents a partially de-identified version of the original text with sensitive information excised. Removed entities may be replaced with placeholders or generic tokens to maintain text coherence and structure. This method streamlines the de-identification process by producing a sanitized text version in a single step. The output 108-1 may also include metadata about the removed entities, such as their types and original positions, to facilitate further processing or auditing.

The redacted text 110 represents a modified version of the target input text, resulting from the iterative de-identification process. This text 110 is provided in the output 108-1 as discussed above or is derived by the system 100 by removing or redacting the entity or entities identified as sensitive by the LLM 106 in its output 108-1. The redacted text 110 retains relevant portions of the target input text, while excluding the detected sensitive entity or sensitive entities. This refined text serves as input for subsequent iterations of the de-identification process. The redacted text 110 acts as an intermediate stage in the iterative refinement, progressing towards the output text (112). By systematically eliminating sensitive entities, the redacted text 110 contributes to the gradual transformation of the original input into a deidentified version.

In one or more embodiments, the redacted text 110 employs a substitution mechanism for sensitive entities. This approach replaces identified sensitive information with placeholders, masks, or tags. For example, personal names might be substituted with “[NAME]”, addresses with “[ADDRESS]”, or numerical identifiers with “[ID]”. This substitution preserves the structural integrity and context of the original text while obscuring specific sensitive details. The placeholders serve as semantic markers, maintaining the general meaning and flow of the text. Such an implementation allows for more nuanced de-identification, potentially retaining valuable contextual information without compromising privacy. The use of standardized tags or masks also facilitates potential re-identification processes if authorized, while still protecting sensitive information during general processing or analysis. This method of constructing the redacted text 110 enhances the versatility of the de-identification system, allowing for tailored levels of information preservation based on specific use-case requirements.

In one or more embodiments, the redacted text 110 implements a relexification strategy for sensitive entities. Rather than using generic placeholders, the system replaces a sensitive entity with a consistently relexified version. Relexification involves substituting the original sensitive information with fabricated, yet plausible and contextually appropriate, alternatives. For instance, the name “John Smith” might be consistently replaced with “Alex Johnson” throughout the text and across texts (e.g., across different FIHR resources or fields within the same or different longitudinal patient records). This approach maintains the linguistic structure and readability of the original content while ensuring privacy protection. The relexification process employs algorithms that generate contextually suitable replacements, preserving different characteristics, such as name origin, gender, or numerical patterns in identifiers. Beneficially, the system maintains consistency across the document and across different documents, using the same relexified version for a unique sensitive entity. This consistency preserves relationships and references within the text, allowing for more meaningful analysis of the deidentified data. The relexification method in creating the redacted text 110 offers a balance between privacy protection and data utility, enabling more NLP and analysis tasks on the deidentified text.

The prompt 104-2 is a structured input provided to an LLM in the iterative de-identification process. This prompt comprises the redacted text 110, a refined version of the original text with previously identified sensitive entities removed or modified. The prompt 104-2 serves as a query or instruction to the LLM, directing the model to analyze the remaining content for additional sensitive information. The format and content of the prompt 104-2 may include specific instructions or context to guide the LLM's analysis, such as criteria for identifying sensitive entities or guidelines for determining sensitivity based on the text's context. By incorporating the updated redacted text 110, the prompt 104-2 enables the system to perform subsequent iterations of sensitivity analysis on progressively refined versions of the original text. This iterative approach, facilitated by the prompt 104-2, enhances the thoroughness and accuracy of the de-identification process.

In one or more embodiments, the prompt 104-2 incorporates explicit instructions for the LLM to focus on specific sensitive entity types from a predetermined set. This set of sensitive entity types might include various categories, such as personal names, addresses, social security numbers, medical conditions, or financial information. The prompt structure explicitly enumerates these entity types, directing the LLM's attention to these categories within the redacted text 110. For example, the prompt might instruct: “Identify and list any instances of personal names, addresses, and social security numbers in the following text.” This targeted approach enhances the efficiency and precision of the de-identification process. By specifying the types of sensitive information to be identified or removed, the system reduces the likelihood of false positives or overlooked sensitive data. The predetermined set of sensitive entity types can be customized based on the specific domain or regulatory requirements of the data being processed. This method allows for a more granular and controlled de-identification process, ensuring that the LLM focuses on the most relevant and critical types of sensitive information in an iteration.

In one or more embodiments, the prompt 104-2 maintains consistency with the prompt 104-1 by specifying the same set of sensitive entity types. This approach ensures a uniform focus throughout the iterative de-identification process. The predetermined set of sensitive entity types, such as personal names, addresses, and social security numbers, remains constant across both prompts. By maintaining this consistency, the system enables a systematic and thorough examination of the text for specific categories of sensitive information. The LLM receives identical instructions in both iterations, allowing for a comprehensive sweep of the designated sensitive entity types. This consistency facilitates a more reliable comparison between the results of the first and second LLM outputs 108-1 and 108-2. The unchanging set of sensitive entity types across prompts aids in tracking the effectiveness of the de-identification process, as any remaining instances of these entity types in the redacted text 110 become more apparent. This method promotes a standardized approach to sensitive entity detection throughout the iterative process, potentially improving the overall accuracy and completeness of the de-identification effort.

In one or more embodiments, the prompt 104-2 introduces a distinct set of sensitive entity types compared to those specified in the prompt 104-1. This approach implements a multi-layered de-identification strategy, targeting different categories of sensitive information in successive iterations. For example, the prompt 104-1 might focus on identifying personal names, addresses, and phone numbers, while the prompt 104-2 shifts attention to medical conditions, financial data, and professional credentials. By varying the sensitive entity types between prompts, the system conducts a more comprehensive and nuanced analysis of the text. This method allows for the detection of diverse sensitive information that may be overlooked in a single-category approach. The alternating focus between prompts can address potential interdependencies or contextual sensitivities that emerge after the initial de-identification pass. This dynamic approach enhances the system's ability to capture a broader spectrum of sensitive information, potentially uncovering less obvious or secondary sensitive entities that become more apparent once the primary sensitive information has been removed or masked.

Specifying different sets of predefined sensitive types over multiple prompts enhances the LLM's accuracy in identifying sensitive entities through a focused, iterative approach. This method uses task-specific attention, allowing the LLM to concentrate on a narrower range of entity types in a prompt. By limiting the scope of an identification task, the LLM can allocate more of its computational resources and attention to specific categories of sensitive information. This focused approach reduces the cognitive load on the model, potentially leading to higher precision in entity recognition.

The iterative nature of this method also enables the LLM to perform multiple passes over the text, with a different sensitivity lens. This multi-pass strategy can uncover contextual sensitivities that might be overlooked when attempting to identify more types simultaneously. For instance, certain entities may become apparent as sensitive once other types of information have been identified or removed.

Furthermore, this approach allows for the application of specialized prompts tailored to a set of sensitive entity types. These targeted prompts can incorporate specific guidelines or examples relevant to particular categories, further improving the LLM's ability to accurately identify sensitive information. The segmented approach also facilitates more nuanced evaluation and refinement of the de-identification process, as the performance for a category of sensitive information can be assessed and optimized independently.

In one or more embodiments, the iterative de-identification system 100 employs a parallel processing approach to optimize performance and reduce overall latency. Multiple prompts, focusing on different sets of predefined sensitive entity types, are simultaneously submitted to one or more LLMs. This parallel execution leverages distributed computing resources, allowing for concurrent analysis of the input text across various sensitivity dimensions. For instance, one prompt might target personal identifiers, while another simultaneously processes financial information, and a third examines medical data.

The system 100 may utilize a single LLM with multi-threading capabilities or distribute the workload across multiple LLM instances. Load balancing algorithms ensure efficient resource utilization, dynamically assigning prompts to available LLM processors. This parallel architecture significantly reduces the cumulative processing time compared to sequential prompt execution.

Upon completion of a parallel task, the system 100 aggregates and reconciles the outputs from the various prompts. A post-processing module integrates the identified sensitive entities from parallel streams, resolving any conflicts or overlaps. This consolidated output then forms the basis for the next iteration of the de-identification process, if required. By parallelizing the prompt execution, system 100 achieves a substantial reduction in overall task latency while maintaining the benefits of focused, category-specific sensitive entity identification.

The output 108-2 refers to the response generated by the LLM after processing the prompt 104-2. This output includes the LLM's analysis and findings regarding sensitive entities present in the redacted text 110. The output 108-2 includes a structured representation of any identified sensitive information, such as entity types, locations within the text, and confidence scores. Depending on the specific implementation, the output 108-2 may also include suggestions for entity removal or replacement. The format of this output is designed to facilitate easy parsing and integration into the subsequent stages of the iterative de-identification process. The output 108-2 is a component in the ongoing refinement of the input text 102, providing the basis for further sensitive entity removal or modification in subsequent iterations. The content and structure of the output 108-2 may vary based on the specific instructions included in the prompt 104-2 and the capabilities of the LLM employed.

In one or more embodiments, the system (100) implements a multi-stage sensitive entity detection process. The system first sends the target input text within prompt 104-1 to the LLM 106. Upon receiving output 108-1, which identifies an initial set of sensitive entities, the system generates a redacted text (110) by removing these entities. The system then constructs prompt 104-2 including this updated text and sends prompt 104-2 to an LLM, which can be the same or different LLM to which prompt 104-1 is sent. The LLM analyzes the redacted text 110 and produces output 108-2. Output 108-2 identifies any remaining sensitive entities that were not detected in the initial pass. This iterative approach allows for more thorough detection of sensitive information. The system leverages the capabilities of potentially different LLMs or repeated use of the same LLM to catch entities that may have been missed in the first iteration. By processing the text multiple times, the system increases the likelihood of identifying context-dependent or subtly sensitive information. This method enhances the overall effectiveness of the de-identification process, ensuring a more comprehensive removal of sensitive data from the output text 112.

The output text 112 represents a product of the LLM-based iterative de-identifier system's (100) processing. This text comprises portions of the original input text 102 with any identified sensitive entities removed. The output text 112 is generated through multiple iterations of analysis and refinement by one or more LLMs. An iteration potentially identifies and eliminates additional sensitive information. The resulting output text 112 preserves the relevant, non-sensitive content from the original input while excluding detected sensitive entities. This curated text maintains the integrity and usefulness of the original information to the extent possible, while significantly reducing or eliminating the risk of exposing sensitive data. The output text 112 is subsequently stored on a non-transitory, computer-readable medium 114 for future access, use, or further processing as needed.

In one or more embodiments, the output text 112 serves as a useful resource for data analysts while maintaining privacy and confidentiality. The LLM-based iterative de-identifier system 100 has effectively removed any identified sensitive entity from the original input text, producing a sanitized version suitable for various analytical purposes. Data analysts can utilize this de-identified output text 112 to train machine learning models without risking exposure of sensitive information. The output text 112 retains the structure and non-sensitive content of the original data, allowing for meaningful pattern recognition and feature extraction. Machine learning algorithms can be applied to this sanitized text to develop models for numerous tasks, such as sentiment analysis, topic classification, or natural language processing. Furthermore, the output text 112 enables data analysts to perform exploratory data analysis, statistical modeling, and other analytical tasks without compromising data subjects' privacy. This approach strikes a balance between data utility and protection of sensitive information, facilitating responsible data science practices. By leveraging the deidentified output text 112, organizations can derive valuable insights and develop powerful machine learning models while adhering to data protection regulations and ethical guidelines.

In one or more embodiments, the LLM-based iterative de-identifier system 100 enhances the output text 112 by implementing a replacement strategy for sensitive entities. Instead of simply removing identified sensitive information, the system substitutes these entities with crafted alternatives. These alternatives may take the form of generic placeholders, semantic tags, data masks, or consistently relexified entities. Placeholders might include general terms like “[NAME]” or “[ADDRESS]” to maintain readability while obscuring specific details. Semantic tags could provide additional context, such as “[PERSON_NAME]” or “[MEDICAL_CONDITION]”, preserving the entity type without revealing sensitive data. Data masks might partially obfuscate information, e.g., “XXX-XX-1234” for a social security number. Relexification involves replacing sensitive entities with fictitious but consistent alternatives throughout the text, maintaining referential integrity. This approach preserves the structure and flow of the original text, enabling more nuanced analysis and potentially improving the performance of machine learning models trained on the data. By employing these replacement techniques, the system generates an output text 112 that balances data utility with privacy protection, allowing for more comprehensive analysis while safeguarding sensitive information.

In one or more embodiments, the LLM-based iterative de-identifier system 100 is integrated into a multi-tenant provider network service. The service offers customers a scalable, cloud-based solution for sensitive data de-identification. A tenant receives a dedicated instance of the system, ensuring data isolation and security. The multi-tenant architecture allows for efficient resource allocation and cost-effective implementation across multiple customers. Tenants interact with the system through secure APIs, submitting their input texts for processing. The service leverages containerization technologies to maintain separation between tenant data and processes. Load balancing mechanisms distribute incoming requests across available resources, optimizing performance and responsiveness. The system employs authentication and authorization protocols to prevent unauthorized access to tenant data or de-identification results. Customers can customize de-identification parameters, such as sensitivity thresholds or replacement strategies, to align with their specific requirements. The multi-tenant design facilitates seamless updates and improvements to the underlying LLM models and de-identification algorithms, benefiting multiple customers simultaneously. This cloud-based implementation enables organizations to leverage advanced de-identification capabilities without the need for significant on-premise infrastructure or expertise, making sophisticated data protection accessible to a wide range of businesses and industries.

In this embodiment, the LLM-based iterative de-identifier system 100 is deployed as an on-premise solution for customers who prioritize data locality and direct control over their sensitive information processing. The system is purchased from a specialized sensitive entity de-identification vendor and installed within the customer's own infrastructure. This deployment model ensures that data remains within the customer's secure environment, never leaving their premises. The vendor provides the core software components, including the LLM integration modules, iterative processing logic, and user interfaces. Customers have the flexibility to integrate the system with their existing data storage and processing systems. The on-premise installation allows for customization of the LLMs used, enabling customers to fine-tune the models for their specific industry or data types. Regular updates and patches are provided by the vendor to maintain system efficacy and security. This approach may require more upfront investment in hardware and ongoing maintenance but offers enhanced control over data governance and compliance. The on-premise deployment also facilitates integration with existing security protocols and audit mechanisms, ensuring alignment with the organization's overall data protection strategy. By implementing the system 100 on-premise customers can leverage advanced de-identification capabilities while maintaining strict control over their sensitive data processing environment.

### 3. CREATING A NEW INPUT TEXT FOR A NEXT ITERATION OF AN ITERATIVE DE-IDENTIFICATION PROCESS BY ELIMINATING A SPECIFIC ELEMENT FROM A PREVIOUS VERSION OF THE TEXT

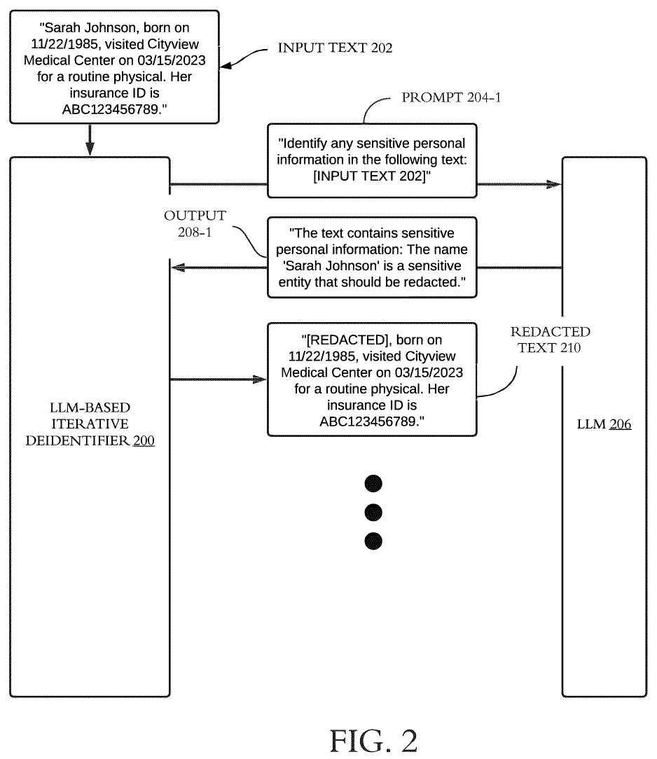

FIG. 2 illustrates creating a new input text for a next iteration of an iterative de-identification process by eliminating a specific element from a previous version of the text in accordance with one or more embodiments. The LLM-based iterative de-identifier system 200 begins with an input text 202 that serves as the initial data to be processed. This text is sent to an LLM 206 as part of a prompt 204-1. The LLM processes this input and generates an output 208-1, indicating the presence of a sensitive entity within the text.

Upon receiving this output, the system 200 determines a redacted text (210). This redacted text is derived from the input text 202. The redacted text 210 excludes the identified sensitive entity. In particular, the redacted text 210 is generated by the system 100 based on removing the sensitive entity from the input text 202 and replacing it with a placeholder, tag, mask, hash value, or relexified entity.

The removal of a sensitive entity from the input text 202 can be accomplished through various methods of obfuscation or replacement. One approach involves substituting the sensitive entity with a placeholder, which could be a generic term or symbol indicating the presence of redacted content. Alternatively, the system 200 may employ tags to demarcate the location of the removed entity, preserving the structural integrity of the text while obscuring the sensitive information. Masking techniques can also be utilized, where characters of the sensitive entity are replaced with a uniform character (e.g., asterisks or ‘X’s), maintaining the entity's length but concealing its content.

For more secure applications, the sensitive entity could be replaced with a hash value. This method involves applying a cryptographic hash function to the entity, producing a fixed-length string that represents the original text but is irreversible. Relexification offers another approach, where the sensitive entity is replaced with a semantically similar but non-sensitive term or phrase. This technique preserves the overall meaning and readability of the text 210 while effectively anonymizing the sensitive information.

The choice of replacement method depends on the specific requirements of the de-identification process, such as the level of security needed, the importance of maintaining text structure, and the necessity for human readability of the output. By employing these techniques, the LLM-based iterative de-identifier system 200 can effectively remove sensitive entities while retaining the utility and coherence of the processed text.

The system 200 then proceeds to send a second prompt to an LLM. This LLM may be the same as or different from the LLM 206 to which prompt 204-1 is sent. The second prompt includes the newly created, redacted text 210. This iterative process continues, with the system repeatedly sending prompts to LLMs and refining the input text based on the outputs received.

Through these iterations, the system progressively identifies and removes sensitive entities from the text. The result is an output text that includes relevant portions of the original input while excluding any identified sensitive information. This output text is then stored on a non-transitory, computer-readable medium for future use or reference.

### 4. OUTPUT FROM A LANGUAGE MODEL THAT INCLUDES A MODIFIED VERSION OF THE INPUT TEXT

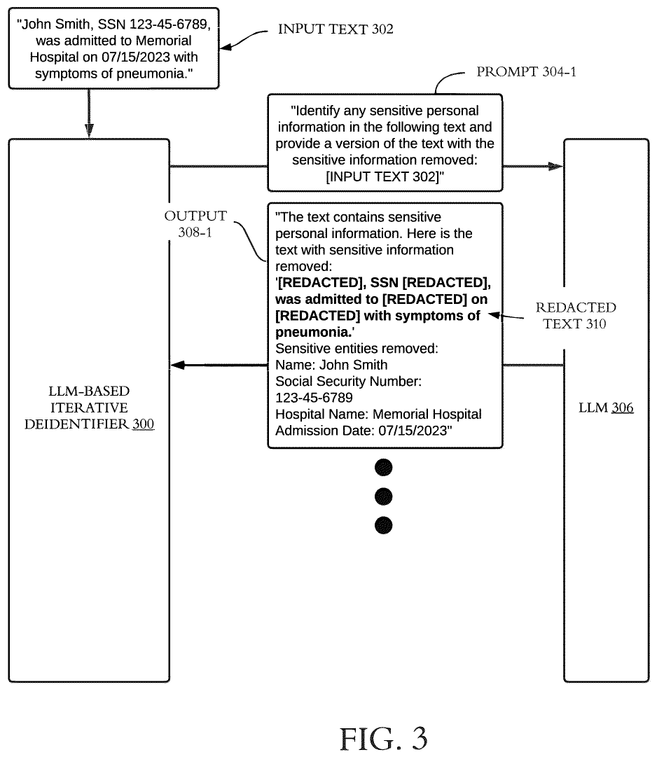

FIG. 3 illustrates an output from a language model that includes a modified version of the input text in accordance with one or more embodiments.

FIG. 3 illustrates the LLM-based iterative de-identifier system 300 and its method for identifying and removing sensitive entities from textual data. The system begins with an input text 302, which serves as the initial content for de-identification. This text is incorporated into a prompt 304-1, which is then sent to an LLM 306. The LLM processes the prompt and generates an output 308-1. This output indicates the presence of a sensitive entity within the input text.

Based on the output 308-1, the system determines a redacted text 310. The redacted text 310 is derived from the original input but excludes the identified sensitive entity. This step demonstrates the system's ability to iteratively refine the text by removing sensitive information. The output 308-1 directly provides the redacted text 310 as determined by the LLM 306. This direct provision streamlines the process, allowing for efficient text updating without additional processing steps.

The iterative process continues, where the redacted text 310 is used to create a second prompt. This second prompt is then sent to an LLM, which may be the same as or different from the LLM 306. The cycle of prompting, analysis, and text refinement continues until predetermined termination conditions are met. The result is an output text stored on a non-transitory, computer-readable medium, including relevant portions of the original input while excluding identified sensitive entities.

The prompt 304-1 sent to the LLM 306 is designed to elicit a specific response that facilitates the generation of the redacted text 310. This prompt includes explicit instructions for the LLM to identify sensitive entities and propose a modified version of the input text with these entities removed. The prompt may include directives such as “Identify any sensitive information in the following text and provide a revised version with the sensitive content removed.” By structuring the prompt in this manner, the system guides the LLM to perform entity identification and text modification.

The LLM 306 processes these instructions along with the input text, leveraging its natural language understanding capabilities to recognize sensitive information. Upon completion of its analysis, the LLM generates the output 308-1; this flags the sensitive entities and includes the revised text, effectively creating the redacted text 310. This approach streamlines the de-identification process by combining the detection and removal steps into a single LLM interaction. The crafted prompt enables the system to obtain a ready-to-use, de-identified version of the text directly from the LLM's output, reducing the need for additional processing or manual intervention.

In one or more embodiments, the prompt 304-1 includes specific directives for the LLM 306 to both identify and remove sensitive entities and replace them with appropriate substitutes. These substitutes may take the form of placeholders (e.g., “[REDACTED]”), semantic tags (e.g., “<PERSON>”), character masks (e.g., “XXXX”), or relexified values (e.g., replacing “John Doe” with “Person A”).

The prompt might be structured as follows: “Identify sensitive information in the given text. Replace a sensitive entity with a suitable placeholder, tag, mask, or relexified value. Provide the modified text with these replacements.” These instructions guide the LLM 306 to perform an analysis of the input text, recognizing various types of sensitive information. The LLM 306 then generates the output 308-1, which includes the modified text—now serving as the redacted text 310—with sensitive entities replaced according to the specified criteria.

This approach offers several advantages. One, it preserves the structure and readability of the original text while ensuring sensitive information is obscured. Two, the use of semantic tags or relexified values can maintain contextual information, which may be valuable for downstream analysis or processing tasks. Three, this method provides flexibility regarding how different types of sensitive information are handled, allowing for customized redaction strategies based on the nature of the data and the specific requirements of the de-identification process.

### 5. GROUPING SENSITIVE INFORMATION TYPES, QUERYING LANGUAGE MODELS WITH SPECIFIC PROMPTS FOR GROUPS, AND COMBINING THE RESULTS

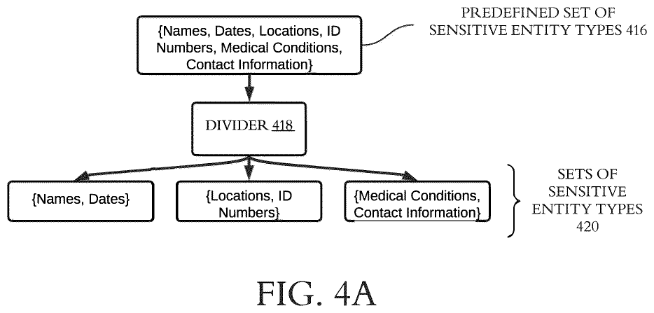

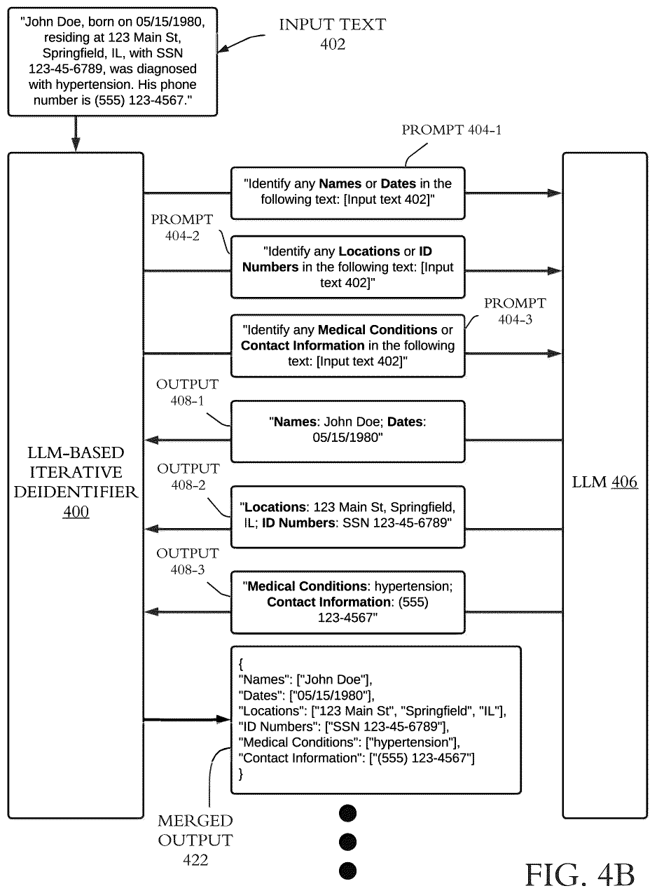

FIG. 4A and FIG. 4B together illustrate grouping sensitive information types, querying language models with specific prompts for groups, and combining the results in accordance with one or more embodiments.

Referring to FIG. 4B, an LLM-based iterative de-identifier system 400 comprises a hardware processor that executes the de-identification method. An input text 402 undergoes iterative processing by the system 400 to identify and remove sensitive entities. The system employs one or more LLMs 406 to analyze the input text.

The process begins with the generation of a prompt 404-1, which includes the input text or a portion thereof. This prompt is sent to the LLM 406, which produces an output 408-1. The output indicates if any sensitive entities are present in the text. Based on this analysis, the system updates the input text, removing identified sensitive entities.

The system then generates subsequent prompts, such as a second prompt, which includes the updated text. These prompts are sent to the same or different LLMs for further analysis. This iterative process continues, with an iteration refining the text by removing sensitive information.

Referring now to FIG. 4A, a divider 418 of the system 400 segments a predefined set of sensitive entity types 416 into a predetermined number of sets 420. This division allows for parallel processing of different sensitive entity categories. Referring again to FIG. 4B, the system 400 generates multiple prompts 404-1, 404-2, 404-3 based on these sets, targeting specific types of sensitive information.

These prompts are sent to one or more LLMs, which may include LLM 406 or additional models. The LLMs analyze the text for sensitive entities within their assigned categories. The system then collects the outputs 408-1, 408-2, 408-3 from these parallel processes.

A merging step combines the multiple outputs into a merged output 422. This consolidated result provides a comprehensive view of identified sensitive entities across different categories. The iterative nature of the process, combined with the parallel processing of entity types, provides a thorough and efficient de-identification of the input text.

The determination of a redacted text for inclusion in the parallel prompts of the next iteration is based on the merged output 422 from the current iteration. This merged output consolidates the results of multiple LLM analyses across various sensitive entity types. The system processes this comprehensive data to identify and remove sensitive entities from the original text.

Specifically, the merged output 422 includes information about sensitive entities detected across different groups of sensitive entity types in the current iteration. The system uses this information to systematically redact or replace the identified sensitive entities in the input text of the current iteration. This redaction process involves removing the sensitive information while preserving the overall structure and context of the text where possible, possibly employing placeholders, tags, masks, or relexified values as replacements for the removed sensitive information.

After the redaction process, the resulting text becomes the redacted text for the next iteration. This new text maintains the relevant, non-sensitive information from the input to the current iteration while excluding the sensitive entities identified in the merged output in the current iteration. The system then incorporates this redacted text into the parallel prompts in the next iteration.

By basing the redacted text for the next iteration on the merged output 422 of the current iteration, the system ensures a comprehensive approach to de-identification. This method allows for the parallel consideration of multiple types of sensitive information, identified by various LLM analyses. The resulting redacted text represents a more thoroughly de-identified version of the input text to the current iteration, ready for further analysis in the next iteration of the process.

Referring again to FIG. 4A, in one or more embodiments, the divider 418 optimizes the LLM-based de-identification process by partitioning the predefined set of sensitive entity types 416 into k sets of sensitive entity types. The value of k is selected to maximize LLM performance. This optimization considers various factors, such as the LLM's processing capabilities, memory constraints, and the complexity of the sensitive entity types.

The system determines the optimal k value through empirical testing and performance analysis. This process involves running the de-identification pipeline with varying k values and measuring key performance indicators, such as processing time, accuracy of sensitive entity detection, and resource utilization. The optimal k strikes a balance between parallelization benefits and the overhead of managing multiple LLM instances.

Once the optimal k is established, the divider 418 employs clustering algorithms or domain-specific heuristics to group related sensitive entity types. This grouping ensures that a set of the k sets includes a coherent subset of entity types, potentially improving the LLM's ability to identify related sensitive information within a single pass. The resulting k sets 420 are then used to generate k distinct prompts 404-1, 404-2, 404-3, . . . , 404-k for the LLM processing pipeline as illustrated in FIG. 4B.

This optimized division allows the system to leverage parallel processing effectively, distributing the workload across multiple LLM instances or sequential runs. By tailoring the number of sets to the LLM's performance characteristics, the system achieves improved throughput and potentially higher accuracy in sensitive entity detection. The optimization process may be periodically re-evaluated to adapt to changes in LLM capabilities or shifts in the nature of the sensitive entity types being processed.

### 6. IDENTIFYING DIFFERENT TYPES OF SENSITIVE INFORMATION USING SPECIALIZED PROMPTS AND LANGUAGE MODELS

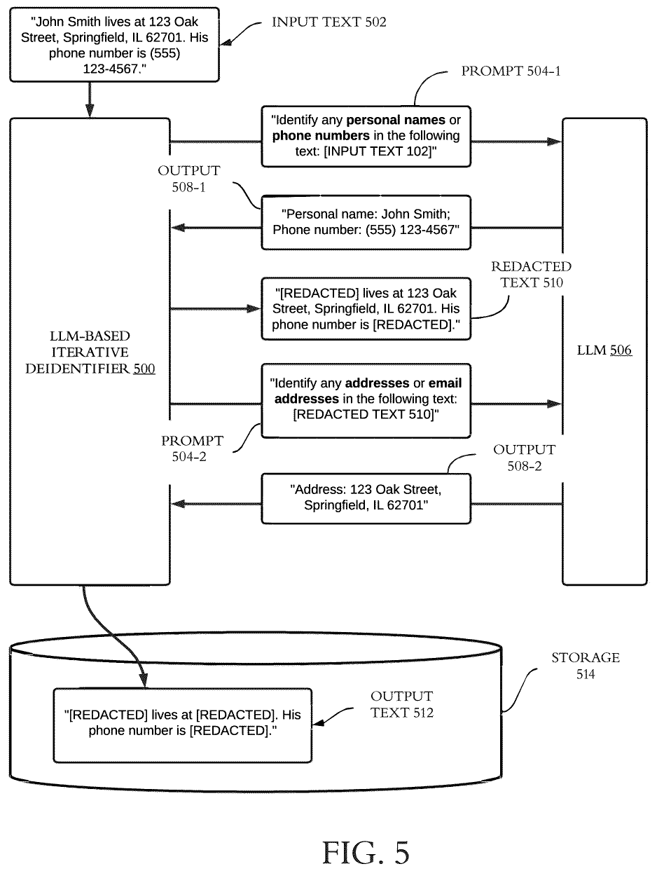

FIG. 5 illustrates identifying different types of sensitive information using specialized prompts and language models in accordance with one or more embodiments.

The LLM-based iterative de-identifier system 500 implements a method for identifying and removing sensitive entities from input text. The system begins with an input text 502, which is processed through an iterative cycle of analysis and refinement. Initially, the input text 502 is incorporated into a prompt 504-1. This prompt is then sent to an LLM (506 for analysis.

The LLM 506 generates an output 508-1, which identifies an entity within the second input text as sensitive. Based on this identification, the system creates a third input text 510 by removing the identified sensitive entity from the second input text. This refined text forms the basis of a second prompt 504-2, which is subsequently sent to an LLM (e.g., LLM 506) for further analysis.

The LLM processes the prompt 504-2 and produces an output 508-2. This output may identify additional sensitive entities of different types. The system allows for the use of either the same LLM or different LLMs for the first and second analyses, providing flexibility in the de-identification process.

The iterative nature of the system is evident in the potential for multiple cycles of text refinement and LLM analysis. An iteration may focus on different sets of sensitive entity types. For example, the prompt 504-1 may instruct the LLM to identify entities from a first set of sensitive types, while the prompt 504-2 targets a second, distinct set of sensitive entity types.

Through this iterative process, the system progressively refines the input text, removing sensitive entities of various types. The result is an output text 512 that retains relevant portions of the original input while excluding any identified sensitive information. This output text is then stored on a non-transitory, computer-readable medium 514 for future use or reference.

The system's design allows for thorough and nuanced de-identification, addressing multiple types of sensitive information across repeated analyses. By leveraging the capabilities of LLMs and employing an iterative approach, the system enhances the accuracy and completeness of the de-identification process.

### 7. MASKING MULTIPLE SENSITIVE ELEMENTS IN A TEXT BY REPLACING THEM WITH A UNIFORM PLACEHOLDER OR HASH VALUE

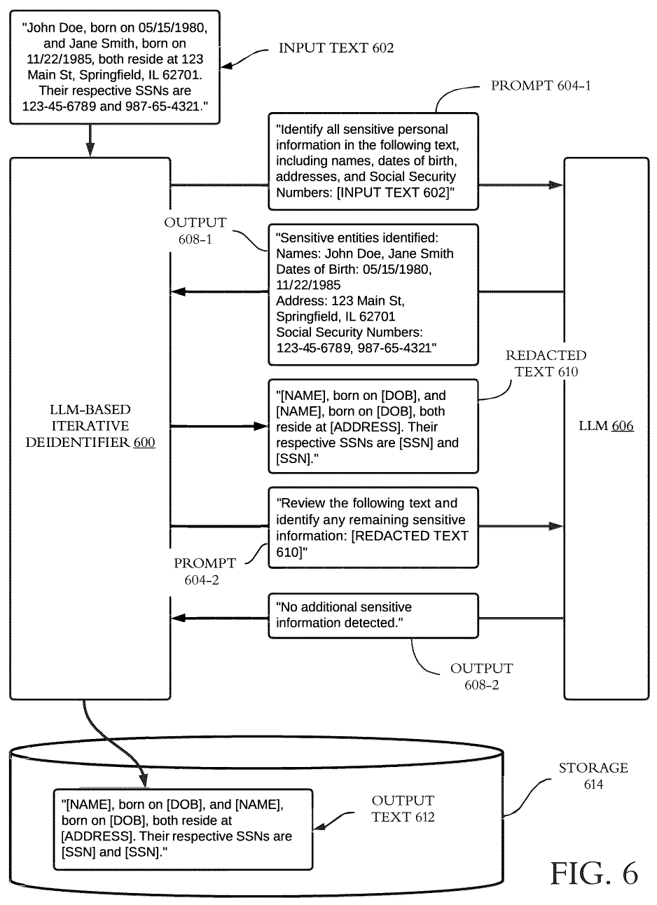

FIG. 6 illustrates masking multiple sensitive elements in a text by replacing them with a uniform placeholder or hash value in accordance with one or more embodiments.

A large language model (LLM)-based iterative de-identifier system 600 processes an input text 602 to identify and remove sensitive entities. This process begins with the input text 602 being incorporated into a prompt 604-1. The prompt 604-1 is then sent to an LLM 606 for analysis. The LLM 606 generates an output 608-1, indicating the presence of sensitive entities within the text.

Based on the output 608-1, the system determines a redacted text 610. This redacted text 610 is derived from the input text 602, which may be identical to or a portion of the input text 602. The redacted text 610 excludes the identified sensitive entity. The system then formulates a prompt 604-2 including the redacted text 610 and sends this prompt to an LLM. This LLM may be the same as or different from the LLM 606.

The LLM processes the prompt 604-2 and produces an output 608-2. This iterative process continues, with an iteration refining the input text by removing identified sensitive entities. The system may replace multiple sensitive entities with a uniform mask value or hash value. The iteration concludes when predefined termination conditions are met.

Upon completion of the iterative process, the system generates an output text 612. This output text 612 includes relevant portions of the original input text while excluding identified sensitive entities. The output text 612 is then stored on a non-transitory, computer-readable medium 614 for future use or reference. This method ensures thorough de-identification of sensitive information while preserving the text's utility.

### 8. CONCLUDING AN ITERATIVE SENSITIVE INFORMATION DETECTION WHEN NO FURTHER SENSITIVE ELEMENTS ARE FOUND IN THE TEXT

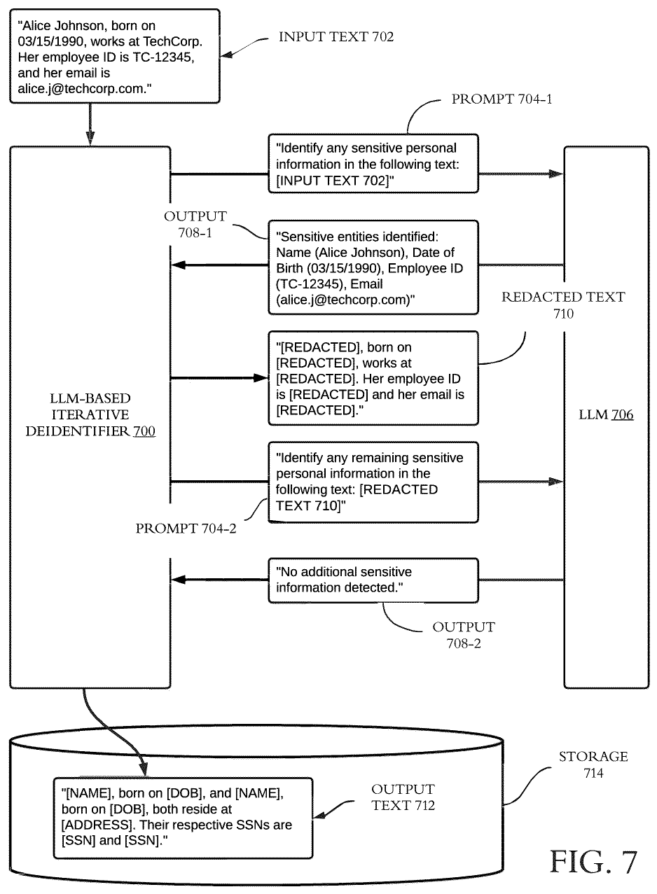

FIG. 7 illustrates concluding an iterative sensitive information detection when no further sensitive elements are found in the text in accordance with one or more embodiments.

An LLM-based iterative de-identifier system 700 implements a method for identifying and removing sensitive entities from textual data. The system begins with an input text 702, which serves as the initial data to be processed. This text is sent to an LLM 706 via a first prompt 704-1. The LLM 706 analyzes the text and produces an output 708-1, indicating the presence of sensitive entities within the input.

Based on this output, the system generates a redacted text 710 by removing the identified sensitive entity from the input text 702. This updated text is then sent to an LLM through a prompt 704-2. The LLM processes this refined input and generates an output 708-2. The system repeats this iterative process, continuously refining the input text and querying the LLMs until specific termination conditions are met.

One such termination condition occurs when the output 708-2 indicates there are no remaining sensitive entities in the processed text. Upon meeting this condition, the system concludes the iterative identification process. The result of this iterative de-identification is an output text 712 that retains relevant portions of the original input while excluding identified sensitive entities.

The system stores this de-identified output text 712 on a non-transitory, computer-readable medium 714, ensuring persistence of the processed data. FIG. 7 effectively demonstrates the cyclical nature of the de-identification process, showcasing how the system leverages LLMs to progressively refine and sanitize the input text through multiple iterations.

### 9. LIMITING THE SENSITIVE INFORMATION DETECTION PROCESS TO A PREDETERMINED NUMBER OF ITERATIONS

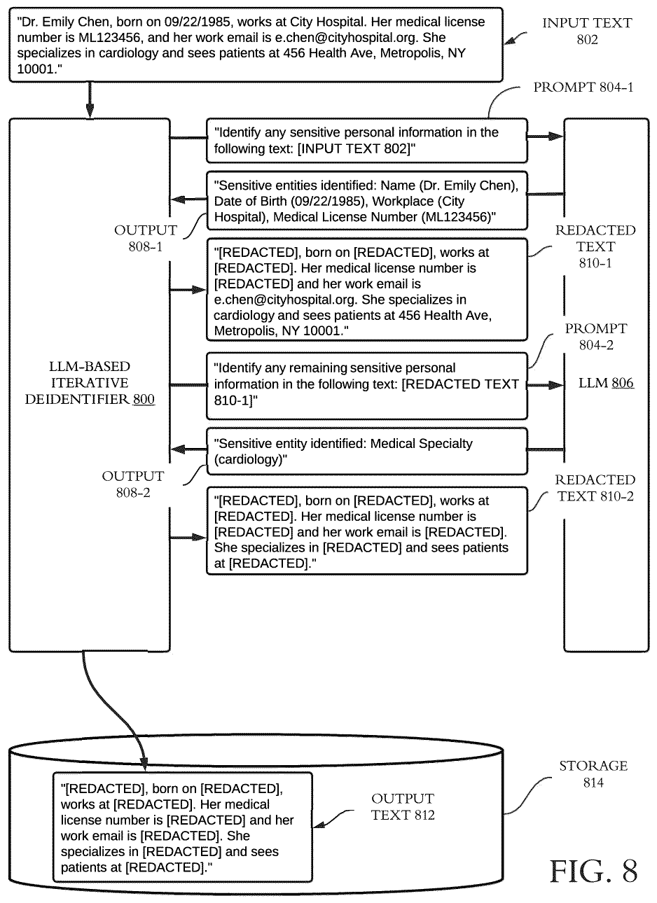

FIG. 8 illustrates limiting the sensitive information detection process to a predetermined number of iterations in accordance with one or more embodiments.

A large language model (LLM)-based iterative de-identifier system 800 implements a method for identifying and removing sensitive entities from textual data. The system begins with an input text (802), which undergoes an iterative process to identify sensitive information. This process involves sending prompts 804-1 and 804-2 to one or more LLMs 806. The LLM analyzes the input text and produces outputs 808-1 and 808-2, indicating the presence of sensitive entities.

Upon receiving the LLM's output 808-1, the system generates redacted text 810-1 by removing the identified sensitive entity from input text 802. This updated text serves as the basis for subsequent iterations. The iterative cycle continues, with a round refining the text further by identifying and removing additional sensitive entities. Upon receiving the LLM's output 808-2, the system generates redacted text 810-2 by removing the identified sensitive entity from redacted text 810-1. The process terminates based on a predetermined number of iterations.

The result of this iterative de-identification process is an output text 812 that preserves relevant portions of the original input while excluding identified sensitive entities. This de-identified text is then stored on a non-transitory, computer-readable medium 814 for future use or reference. The system's architecture allows for flexibility in LLM usage, permitting the use of either a single LLM or multiple distinct LLMs throughout the iterative process.

In one or more embodiments where the number of iterations is set to two, the LLM-based iterative de-identifier system 800 executes a concise yet effective de-identification process. The system initiates with the input text 802, which undergoes two distinct cycles of analysis and refinement. During the first iteration, the system sends the initial prompt 804-1 including the input text to the LLM 806. The LLM's output 808-1 identifies sensitive entities within the text. Based on this output, the system generates a redacted text (810-1) by removing the detected sensitive information.

The second and final iteration commences with the system sending a new prompt 804-2 including the redacted text 810-1 to the LLM. This second pass allows for the identification of any remaining or previously undetected sensitive entities. Following the LLM's output 808-2, the system performs a final refinement of the text. The resulting output text 812 represents a twice-filtered version of the original input with sensitive entities removed in both passes. This two-iteration approach strikes a balance between thorough de-identification and computational efficiency, offering a pragmatic solution for scenarios where processing time is a consideration. The system then stores the final output text 812 on the non-transitory computer-readable medium 814, concluding the de-identification process.

Selecting the number of iterations for the LLM-based iterative de-identifier system 800 can be approached through various methods, tailored to specific requirements and constraints. One approach involves empirical testing, where the system administrators analyze performance across different iteration counts using a diverse set of input texts. This method helps identify an optimal balance between thoroughness of de-identification and computational resource utilization. Another strategy employs dynamic iteration selection based on the complexity and length of the input text 802. Longer or more intricate texts may require additional iterations to ensure comprehensive sensitive entity removal.

A threshold-based method can also be implemented, where iterations continue until the percentage of identified sensitive entities falls below a predetermined threshold. This adaptive approach ensures that the process terminates when the text reaches a satisfactory level of de-identification. Alternatively, a machine learning model could be trained to predict the optimal number of iterations based on features of the input text, such as length, domain, or detected entity types. This predictive model could dynamically adjust the iteration count for a new input, optimizing the de-identification process in real-time.

For applications with strict time constraints, a fixed iteration limit can be set based on average performance metrics. This approach guarantees consistent processing time but may sacrifice some accuracy for particularly complex inputs. In scenarios where maximum security is paramount, the system could be configured to continue iterations until no new sensitive entities are detected in consecutive passes, ensuring the most thorough de-identification at the cost of potentially increased processing time.

### 10. PROCESS FOR ITERATIVE DE-IDENTIFICATION OF SENSITIVE ENTITIES IN AN INPUT TEXT USING LARGE LANGUAGE MODELS (LLMS)

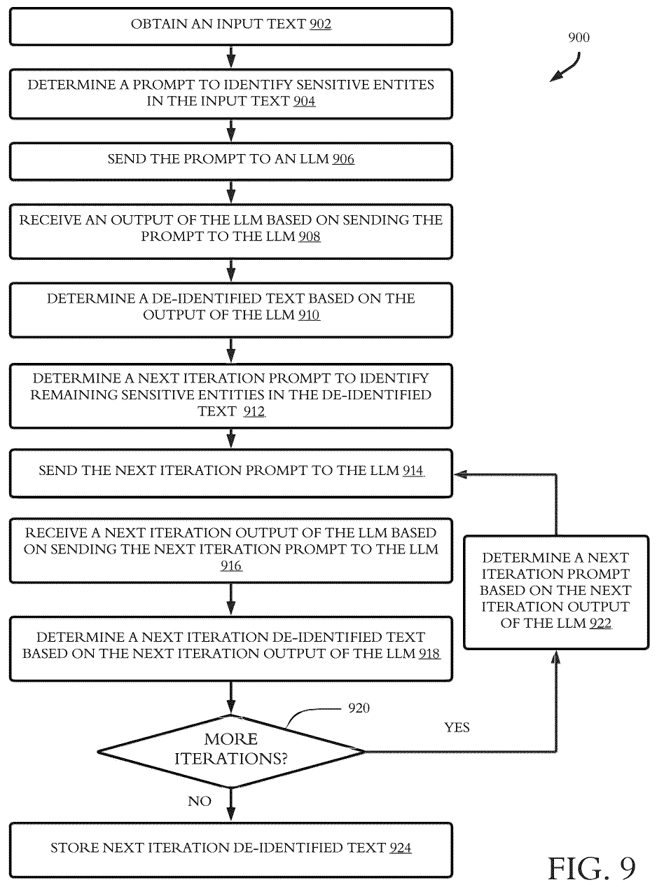

FIG. 9 illustrates a process for iterative de-identification of sensitive entities in an input text using large language models (LLMs) in accordance with one or more embodiments. The process begins by obtaining an input text 902. Subsequently, a prompt is determined to identify sensitive entities within the input text 904. This prompt is then sent to an LLM 906. The method proceeds to receive an output from the LLM based on the sent prompt 908. Using this output, a deidentified text is determined 910.

The process then enters an iterative phase. A next iteration prompt is formulated to identify any remaining sensitive entities in the de-identified text 912. This new prompt is sent to the LLM 914, and a next iteration output is received from the LLM 916. Based on this output, a next iteration de-identified text is determined 918.

At this point, the method evaluates whether or not to perform more iterations 920. If additional iterations are required, the process determines a new next iteration prompt based on the most recent LLM output 922 and returns to the step of sending this prompt to the LLM 914. This cycle continues until no further iterations are deemed necessary. Once the iteration process is complete, the final next iteration deidentified text is stored 924, concluding the method.

This iterative approach enables thorough and progressive removal of sensitive information, leveraging the LLM's capabilities to enhance the accuracy and completeness of the de-identification process.

In one or more embodiments, a prompt transmission to and output reception from a LLM may involve a multi-layered system architecture facilitating bidirectional communication. The process initiates when a prompt is received by an agent system, which functions as an intermediary interface layer between a client that sends the prompt and the core LLM. This agent system preprocesses the incoming prompt through several potential steps: tokenization of the raw text input, application of any relevant system prompts or context windows, and formatting of the payload according to the LLM's expected input schema. The formatted prompt is then transmitted to the LLM's inference endpoint, via API calls over secure network protocols. The LLM processes the input through its transformer (or other suitable) architecture and generates a response, which is returned to the agent system. The agent system then post-processes this output-potentially filtering, formatting, or additional context-before delivering it back to the client. Throughout this process, the agent system may maintain state information about the conversation, manage authentication and rate limiting, log interactions, and handle error conditions. The agent can also implement various control mechanisms such as prompt injection protections, output moderation, and response validation. This architectural pattern allows for sophisticated interaction patterns while abstracting the complexity of direct LLM communication from clients.

### 11. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

The following is an example of a first prompt template used in one or more embodiments to determine the first or initial prompt for the first iteration (e.g., prompt 104-1 of FIG. 1). The line numbers are for purposes of providing a clear example in this disclosure and are not necessarily part of the template itself.

00: system_prompt: ‘As a De-Identification Specialist, your job is to protect patient
01: privacy in medical documents. Use your knowledge of legal medical policies to remove
02: personal information from the text given below following rules like HIPAA. Your
03: role helps with research and keeps patient information private and secure.
04:
05: You have to extract the following entities from the given medical text. Extract
06: all possible word/phrases classified as any of the entity given below. Two same
07: words with different cases are considered as distinct, so detect them separately.
08: Any contraction of a word is also considered as a separate entity. Medicine names
09: or Diagnosis names are not considered as entity here. Strictly follow the guidelines
10: for each entity type given below:
11:
12: {{guidelines}}
13:
14:
15: Output Format:
16:
17: The output format should strictly just be a JSON dictionary with the entity mentioned
18: above as the key and its list of words/phrases found in the text as its value.
19:
20: For e.g., “NAME”: [“A”, “B”, “C”]
21:
22: You must not add any key which is not a part of the guidelines above. You must add
23: all the entity as the keys in the output even if the value list for that is empty.
24:
25: The final output format must look like as follows. You must not produce anything
26: except the json output. Ensure the output can be parsed by Python json.loads.
27:
28:
29: {<entity_type1>: <list_of_words_or_phrases_for_entity_type1>,
30:
31: <entity_type2>: <list_of_words_or_phrases_for_entity_type2>,... and so on}
32:
33:
34: Here is the input text:
35:
36: {{input_text}}’

According to the current example, the prompt for the first iteration, as exemplified by the above prompt template, is a structured query designed to instruct the LLM to perform sensitive entity identification within medical texts. This prompt template instantiates a specialized De-Identification Specialist persona for the LLM. The specialist's role is defined as protecting patient privacy in accordance with legal medical policies such as HIPAA. The prompt provides specific guidelines for entity extraction, which would be populated in the {{guidelines}} placeholder. These guidelines delineate the types of sensitive information to be identified, such as names, dates, or locations. The prompt also specifies the required output format: a JSON dictionary with entity types as keys and lists of identified words or phrases as values. This structured output facilitates subsequent processing steps in the de-identification pipeline. The {{input_text}} placeholder would be filled with the input text. By framing the task as a specific role with clear instructions and output expectations, the prompt leverages the LLM's natural language understanding capabilities to perform targeted sensitive entity identification. This approach aligns with the iterative process disclosed herein, enabling systematic and thorough detection of sensitive information across multiple passes of the text.

The following is an example of a prompt template used in one or more embodiments to determine a second or subsequent prompt for a next iteration (e.g., prompt 104-2 of FIG. 1). The line numbers are for purposes of providing a clear example in this disclosure and are not necessarily part of the template itself.

00: system_prompt: ‘As a De-Identification Specialist, your job is to protect patient
01: privacy in medical documents. Use your knowledge of legal medical policies to remove
02: personal information from the text given below following rules like HIPAA. Your
03: role helps with research and keeps patient information private and secure.
04:
05: You have to extract the following entities from the given partially redacted medical text.
06: Extract all possible words/phrases classified as any of the entity given below that are yet to
07: be removed. Two same words with different cases are considered as distinct, so detect them
08: separately. Any contraction of a word is also considered as a separate entity. Medicine
09: names or Diagnosis names are not considered as entity here. Strictly follow the guidelines
10: for each entity type given below:
11:
12: {{guidelines}}
13:
14: Output Format:
15:
16: The output format should strictly be a JSON dictionary with the entity mentioned above 17:
as the key and its list of words/phrases found in the text as its value.
18:
19: For e.g., “NAME”: [“A”, “B”, “C”]
20:
21: You must not add any key which is not a part of the guidelines above. You must add all the
22: entity as the keys in the output even if the value list for that is empty.
23:
24: The final output format must look like as follows. You must not produce anything except the
25: json output. Ensure the output can be parsed by Python json.loads.
26:
27: {<entity_type1>: <list_of_words_or_phrases_for_entity_type1>,
28: <entity_type2>: <list_of_words_or_phrases_for_entity_type2>,... and so on}
29:
30: Here is the input text:
31:
32: {{partially_redacted_input_text}}’

According to the current example, the prompt for the second and subsequent iterations, exemplified by the above prompt template, represents a refined iteration in the sensitive entity identification process disclosed herein. This prompt maintains the De-Identification Specialist persona established in the first prompt but introduces a modification. The LLM is now instructed to analyze a partially redacted medical text, focusing on identifying any remaining sensitive entities that were not removed in previous iterations. The {{partially_redacted_input_text}} placeholder corresponds to a redacted input text mentioned in, which excludes previously identified sensitive entities. This prompt's structure closely mirrors the first prompt, retaining the same output format requirements and entity type guidelines. However, the key distinction lies in the instruction to identify the sensitive information that has not yet been redacted. This approach aligns with the iterative nature of the process disclosed herein, where a subsequent pass aims to capture any sensitive information that may have been overlooked in earlier iterations. By explicitly directing the LLM to focus on remaining sensitive entities, this prompt enhances the thoroughness of the de-identification process, systematically refining the text until sensitive information is identified and removed.

### 12. PRACTICAL APPLICATIONS, ADVANTAGES, AND IMPROVEMENTS

One or more embodiments address the technical problem of accurately and efficiently deidentifying sensitive entities in textual data using large language models (LLMs). Traditional deidentification methods often struggle with the detection and removal of sensitive information, especially in unstructured or complex texts. These conventional approaches may rely on predefined rules or static entity recognition models, which have limited capacity to identify the diverse range of sensitive entities present in real-world datasets. Additionally, applying an LLM directly to an entire text can be computationally intensive and may not ensure the complete elimination of all sensitive entities.

To overcome these limitations, one or more embodiments encompass an iterative process that systematically identifies and removes sensitive entities using one or more LLMs. By sending portions of the input text to an LLM and analyzing the outputs for indications of sensitive content, one or more embodiments precisely pinpoint specific entities that require removal. This iterative approach allows for continuous refinement of the text, ensuring that sensitive entities are incrementally identified and excluded from subsequent iterations. One or more embodiments enhance the accuracy of deidentification by leveraging the advanced language understanding capabilities of LLMs while effectively managing computational resources. Employing iterative prompts and text updates reduces the likelihood of overlooking sensitive information and improves the overall reliability of the deidentification process.

One or more embodiments offer significant technical advantages by enhancing the accuracy and efficiency of deidentifying sensitive entities in textual data using large language models (LLMs). By implementing an iterative process that repeatedly refines the input text based on the LLM's outputs, one or more embodiments detect and remove sensitive entities that may be missed in a single-pass approach. Traditional deidentification methods often rely on static models or rules that lack the flexibility to handle diverse and context-dependent sensitive information. The iterative interaction with LLMs allows one or more embodiments to adapt dynamically, improving the thoroughness of sensitive entity removal. Additionally, by incrementally reducing the input text and focusing on portions containing sensitive content, one or more embodiments improve or optimize computational resources and reduce or minimize processing time. This results in a more robust deidentification process that better protects sensitive information while maintaining the integrity and utility of the non-sensitive data.

### 13. EXAMPLE LLM ARCHITECTURE

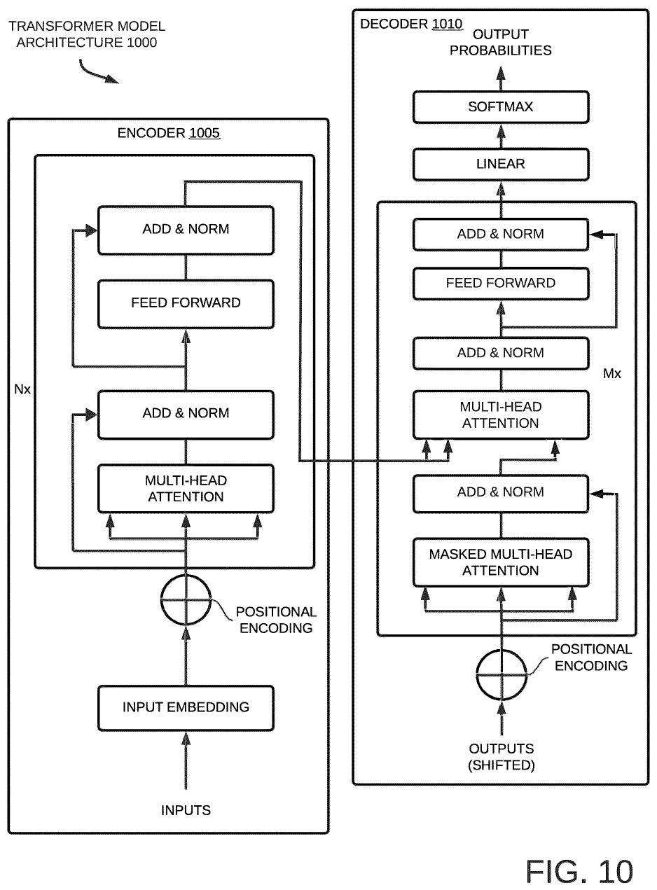

FIG. 10 illustrates an example transformer model architecture 1000 that may be used in the implementation of a LLM, such as LLM 106, 206, 306, 406, 506, 606, 706, or 806 described above with respect to the figures, according to an embodiment of the present disclosure.

The transformer model architecture 1000 may be a neural network design for natural language processing. At its core, the transformer 1000 may encompass an encoder 1005 and a decoder 1010, both leveraging self-attention mechanisms. The architecture 1000 may begin with an input embedding layer that converts tokens into high-dimensional vector representations that may range, for example, from 128 to 1024 dimensions. These embeddings may be augmented with positional encodings to retain sequence order information.

The transformer model architecture 1000's input embedding layer serves as the initial processing stage for converting discrete tokens into continuous vector representations. These dense embeddings may occupy a high-dimensional space, with dimensionality configurations ranging from 128 to 1024, allowing for rich semantic representation of input tokens. The embedding process maps each token to a unique vector that captures the token's semantic properties in the continuous space. Positional encodings are subsequently added to these token embeddings through element-wise addition, introducing position-dependent signals that encode sequential information. These positional encodings can be implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The transformer 1000 may include a multi-head, self-attention mechanism. This may allow the model 1000 to simultaneously attend to different parts of the input sequence, capturing various types of relationships and dependencies. Each attention head may compute query, key, and value vectors, enabling the model to focus on relevant parts of the input when processing each token. Following the attention layers, the architecture 1000 may incorporate feed-forward neural networks with multiple layers and non-linear activation functions.

The multi-head self-attention mechanism forms a component of the transformer architecture 1000, enabling parallel processing of input sequence elements. Each attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers consist of two linear transformations with a non-linear activation function (e.g., ReLU or GELU) between them, processing each position's output independently. This combination of self-attention and position-wise feed-forward networks enables the model to alternate between gathering contextual information across the sequence and applying complex transformations to individual positions, creating a powerful mechanism for sequence processing.

A masked, multi-head attention mechanism in the decoder 1010 of a transformer model 1000 may be designed to prevent the model from attending to future tokens during sequence generation. In this mechanism, multiple attention heads may operate in parallel, each computing query (Q), key (K), and value (V) matrices from the input embeddings. The attention scores may be calculated as the dot product of Q and K, scaled by the inverse square root of the dimension of the keys. A lower triangular mask may be applied to these attention scores before softmax normalization, effectively setting the upper triangular elements to negative infinity. This masking may ensure that each position can only attend to previous positions in the sequence, maintaining the autoregressive property of the decoder. The masked attention scores may then be used to compute a weighted sum of the value vectors. The outputs from the heads may be concatenated and linearly transformed to produce the attention output. This process may allow the decoder to generate tokens sequentially while considering only the previously generated tokens, thus preserving the causal nature of language modeling.

The masked multi-head attention mechanism in the transformer's decoder 1010 implements causal masking to enforce autoregressive generation during sequence processing. Each attention head performs linear projections to create query (Q), key (K), and value (V) matrices from input embeddings through learned weight matrices WQ, WK, and WV respectively. The attention computation follows the formula Attention (Q, K, V)=softmax(QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing each position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the transformer 1000 may employ layer normalization after each sub-layer (self-attention and feed-forward networks) and may introduce residual connections. These residual connections may allow unimpeded information flow through the network. The model may consist of multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for each token position. The normalization process computes the mean and variance of the features, then scales and shifts the normalized values using learned parameters gamma and beta, effectively standardizing the feature distributions throughout the network. Residual connections, implemented as skip connections, add the input of each sub-layer to the transformed output, creating direct paths for gradient flow during backpropagation. The combination of these components follows the formula LayerNorm (x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. Each additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer may involve a linear transformation followed by a softmax function, producing probability distributions over the vocabulary for text generation tasks. This architecture 1000's design may allow for efficient parallel processing of input sequences, making it particularly suitable for handling the extensive datasets used in training LLMs.

The output layer of the transformer architecture implements a vocabulary-sized classification mechanism through a linear transformation followed by softmax activation. The linear transformation projects the decoder's hidden states onto a vocabulary-sized space using a weight matrix W∈R\hat{ }(d_model×|V|), where d_model represents the model's hidden dimension and |V| represents the vocabulary size. The subsequent softmax function normalizes these logits into a proper probability distribution across the entire vocabulary, computing P (token_i)=exp (z_i)/Σ_j exp (z_j), where z_i represents the logit for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring only O(1) sequential operations compared to the O(n) operations needed in recurrent architectures. The model's parallelization efficiency scales particularly well with increasing sequence lengths, making the architecture advantageous for processing the extensive datasets used in large language model training, which often contain billions of tokens across diverse domains and languages.

In one or more embodiments, architectural variations enhance or modify the standard transformer design for LLM implementations. The Sparse Transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The Performer architecture replaces the attention mechanism with kernel-based formulations using random feature decomposition, achieving linear complexity in both compute and memory.

Alternate positional encoding schemes offer various trade-offs. Rotary positional embeddings (RoPE) inject positional information through rotation matrices applied to token embeddings, providing better relative position modeling. Alibi position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash Attention optimizes attention computation through careful management of GPU memory access patterns. Mixture of Experts (MoE) architectures incorporate specialized sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. DeepNorm modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for LLM implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates-input, forget, and output-along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within each layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory Networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures can capture complex dependencies that may be difficult to model with purely sequential approaches, though these architectures may require careful design of graph structure and update rules.

### 13. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 15. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

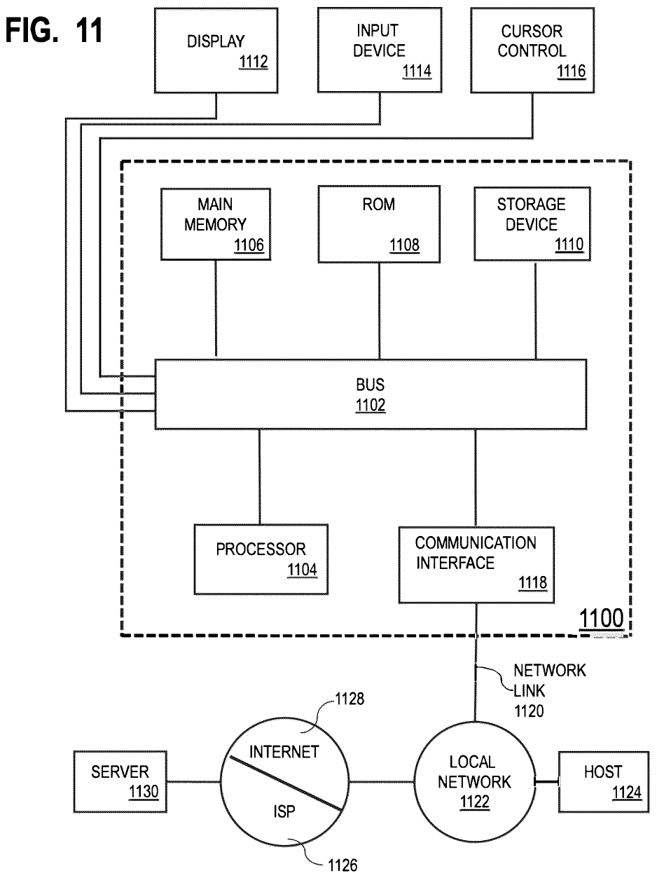

For example, FIG. 11 is a block diagram that illustrates a computer system 1100 upon which an embodiment of the disclosure may be implemented. Computer system 1100 includes a bus 1102 or other communication mechanism for communicating information, and a hardware processor 1104 coupled with bus 1102 for processing information. Hardware processor 1104 may be, for example, a general-purpose microprocessor.

Computer system 1100 also includes a main memory 1106, such as a random-access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or a Solid-State Drive (SSD) is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the worldwide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

### 16. MISCELLANEOUS; EXTENSIONS

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. One or more non-transitory computer-readable media comprising instructions which, when executed by one or more hardware processors, cause performance of operations comprising:
iteratively identifying one or more sensitive entities in a first input text;
generating an output text that comprises at least a portion of the first input text and that does not include the one or more sensitive entities;
storing the output text on a non-transitory computer-readable medium;
wherein iteratively identifying the one or more sensitive entities in the first input text comprises:
determining a second input text, the second input text being the first input text or comprising a portion of the first input text;
sending a first prompt to a first large language model (LLM), wherein the first prompt comprises the second input text;
obtaining a first output of the first LLM based on sending the first prompt to the first LLM, wherein the first output indicates that an entity of the second input text is a sensitive entity;
based on the first output, determining a third input text, wherein the third input text comprises at least a portion of the second input text and does not comprise the entity;
sending a second prompt to a second LLM, wherein the second prompt comprises the third input text;
obtaining a second output of a second LLM based on sending the second prompt to the second LLM; and
wherein the first LLM and the second LLM are a same LLM or are different LLMs.

2. The one or more non-transitory computer-readable media of claim 1, wherein determining the third input text is based on removing the entity from the second input text.

3. The one or more non-transitory computer-readable media of claim 1, wherein the first output comprises the third input text.

4. The one or more non-transitory computer-readable media of claim 1, wherein iteratively identifying the one or more sensitive entities in the first input text comprises:
dividing a predefined set of sensitive entity types into a predetermined number of sets of sensitive entity types;
sending a plurality of prompts to one or more large language models (LLMs), wherein each prompt, of the plurality of prompts, (a) specifies a set of sensitive entity types, of the predetermined number of sets of sensitive entity types, and (b) comprises instructions to determine any sensitive entities in an input text included in the prompt that are any one of the set of sensitive entity types specified in the prompt, wherein the one or more LLMs includes at least one of the first LLM or the second LLM;
obtaining a plurality of outputs based on sending the plurality of prompts to the one or more LLMs; and
merging the plurality of outputs to yield a merged output.

5. The one or more non-transitory computer-readable media of claim 1, wherein:
the entity indicated by the first output as a sensitive entity is a first entity;
the first entity is a first sensitive entity type;
the second output indicates that a second entity of the third input text is a sensitive entity;
the second entity is a second sensitive entity type that is not the first sensitive entity type;
the first prompt comprises instructions to determine any sensitive entities in the second input text that any one of a first set of sensitive entity types specified in the first prompt, the first set of sensitive entity types comprising the first sensitive entity type but not the second sensitive entity type; and
the second prompt comprises instructions to determine any sensitive entities in the third input text that are any one of a second set of sensitive entity types specified in the second prompt, the second set of sensitive entity types comprising the second sensitive entity type but not the first sensitive entity type.

6. The one or more non-transitory computer-readable media of claim 1, wherein:
the first output indicates that a plurality of entities of the first input text are sensitive entities;
the plurality of entities comprises the sensitive entity; and
the operations further comprise determining, based on the first output, the second input text at least by replacing the plurality of entities in at least a portion of the first input text with a same mask value or a same hash value.

7. The one or more non-transitory computer-readable media of claim 1, wherein iteratively identifying the one or more sensitive entities in the first input text comprises:
terminating the iteratively identifying based on determining that the second output indicates that no entities in the second input text are sensitive entities.

8. The one or more non-transitory computer-readable media of claim 1, the operations further comprising:
selecting a number of iterations to perform to identify any sensitive entities in the first input text; and
terminating the iteratively identifying the one or more sensitive entities based on the number of iterations to perform.

9. A method comprising:
iteratively identifying one or more sensitive entities in a first input text;
generating an output text that comprises at least a portion of the first input text and that does not include the one or more sensitive entities;
storing the output text on a non-transitory computer-readable medium;
wherein iteratively identifying the one or more sensitive entities in the first input text comprises:
determining a second input text, the second input text being the first input text or comprising a portion of the first input text;
sending a first prompt to a first large language model (LLM), wherein the first prompt comprises the second input text;
obtaining a first output of the first LLM based on sending the first prompt to the first LLM, wherein the first output indicates that an entity of the second input text is a sensitive entity;
based on the first output, determining a third input text, wherein the third input text comprises at least a portion of the second input text and does not comprise the entity;
sending a second prompt to a second LLM, wherein the second prompt comprises the third input text;
obtaining a second output of a second LLM based on sending the second prompt to the second LLM; and
wherein the first LLM and the second LLM are a same LLM or are different LLMs.

10. The method of claim 9, wherein determining the third input text is based on removing the entity from the second input text.

11. The method of claim 9, wherein the first output comprises the third input text.

12. The method of claim 9, wherein iteratively identifying the one or more sensitive entities in the first input text comprises:
dividing a predefined set of sensitive entity types into a predetermined number of sets of sensitive entity types;
sending a plurality of prompts to one or more large language models (LLMs), wherein each prompt, of the plurality of prompts, (a) specifies a set of sensitive entity types, of the predetermined number of sets of sensitive entity types, and (b) comprises instructions to determine any sensitive entities in an input text included in the prompt that are any one of the set of sensitive entity types specified in the prompt, wherein the one or more LLMs includes at least one of the first LLM or the second LLM;
obtaining a plurality of outputs based on sending the plurality of prompts to the one or more LLMs; and
merging the plurality of outputs to yield a merged output.

13. The method of claim 9, wherein:
the entity indicated by the first output as a sensitive entity is a first entity;
the first entity is a first sensitive entity type;
the second output indicates that a second entity of the third input text is a sensitive entity;
the second entity is a second sensitive entity type that is not the first sensitive entity type;
the first prompt comprises instructions to determine any sensitive entities in the second input text that any one of a first set of sensitive entity types specified in the first prompt, the first set of sensitive entity types comprising the first sensitive entity type but not the second sensitive entity type; and
the second prompt comprises instructions to determine any sensitive entities in the third input text that are any one of a second set of sensitive entity types specified in the second prompt, the second set of sensitive entity types comprising the second sensitive entity type but not the first sensitive entity type.

14. The method of claim 9, wherein:
the first output indicates that a plurality of entities of the first input text are sensitive entities;
the plurality of entities comprises the sensitive entity; and
the method further comprises determining, based on the first output, the second input text at least by replacing the plurality of entities in at least a portion of the first input text with a same mask value or a same hash value.

15. The method of claim 9, wherein iteratively identifying the one or more sensitive entities in the first input text comprises:
terminating the iteratively identifying based on determining that the second output indicates that no entities in the second input text are sensitive entities.

16. The method of claim 9, further comprising:
selecting a number of iterations to perform to identify any sensitive entities in the first input text; and
terminating the iteratively identifying the one or more sensitive entities based on the number of iterations to perform.

17. A system comprising:
at least one device having a hardware processor; and
instructions which, when executed by one or more hardware processors, cause performance of operations comprising:
iteratively identifying one or more sensitive entities in a first input text;
generating an output text that comprises at least a portion of the first input text and that does not include the one or more sensitive entities;
storing the output text on a non-transitory computer-readable medium;
wherein iteratively identifying the one or more sensitive entities in the first input text comprises:
determining a second input text, the second input text being the first input text or comprising a portion of the first input text;
sending a first prompt to a first large language model (LLM), wherein the first prompt comprises the second input text;
obtaining a first output of the first LLM based on sending the first prompt to the first LLM, wherein the first output indicates that an entity of the second input text is a sensitive entity;
based on the first output, determining a third input text, wherein the third input text comprises at least a portion of the second input text and does not comprise the entity;
sending a second prompt to a second LLM, wherein the second prompt comprises the third input text;
obtaining a second output of a second LLM based on sending the second prompt to the second LLM; and
wherein the first LLM and the second LLM are a same LLM or are different LLMs.

18. The system of claim 17, wherein determining the third input text is based on removing the entity from the second input text.

19. The system of claim 17, wherein the first output comprises the third input text.

20. The system of claim 17, wherein iteratively identifying the one or more sensitive entities in the first input text comprises:
dividing a predefined set of sensitive entity types into a predetermined number of sets of sensitive entity types;
sending a plurality of prompts to one or more large language models (LLMs), wherein each prompt, of the plurality of prompts, (a) specifies a set of sensitive entity types, of the predetermined number of sets of sensitive entity types, and (b) comprises instructions to determine any sensitive entities in an input text included in the prompt that are any one of the set of sensitive entity types specified in the prompt, wherein the one or more LLMs includes at least one of the first LLM or the second LLM;
obtaining a plurality of outputs based on sending the plurality of prompts to the one or more LLMs; and
merging the plurality of outputs to yield a merged output.
